(19) United States
(12) Patent Application Publication
(10) Pub. No.: US 2016/0321230 A1
(43) Pub. Date: Nov. 3, 2016

(54) GENERATING A DATA TABLE

(71) Applicant: Facebook, Inc., Menlo Park, CA (US)

(72) Inventors: Hsi Wang, Palo Alto, CA (US); Wojciech Andrzej Lis, Redwood City, CA (US); Catriona Anne Scott, San Francisco, CA (US); Jason Michael Bonta, San Francisco, CA (US); Pieter David Vanderwerff, Mountain View, CA (US)

(21) Appl. No.: 14/699,481

(22) Filed: Apr. 29, 2015

(51) Int. Cl. G06F 17/24; G06F 3/0485

(52) U.S. Cl. CPC G06F 17/246; G06F 3/04855

(57) ABSTRACT

In one embodiment, a method includes generating a table by instantiating a plurality of cell instances along an axis. A first subset of the cell instances may be buffered. For each cell instance of the first subset, buffering the cell instance may include assigning the cell instance to a cell position within a displayable region of a graphical user interface (GUI) of the computing device and rendering content for display in the cell instance. The table may also include a resizable handle for a scrollbar oriented along the axis, the initial size of which may be determined based on the total number of cells and dimensions of the cell instances in the first subset and dimensions of unbuffered ones of the cell instances. After a predetermined period of time during which no user scroll input is received, a second subset of the cell instances may be buffered.

### TECHNICAL FIELD

This disclosure generally relates to an improved method of displaying an object-based representation of a graphical user interface (GUI).

### BACKGROUND

A user interface (UI), in the industrial design field of human-machine interaction, is the space where interactions between humans and machines occur. The goal of the interactions between a human, often referred to as a “user,” and a machine at the user interface is the user's control of the machine and its operations (e.g., through user input) and machine feedback (e.g., through program output). A GUI is a type of user interface that allows users to interact with software applications executing on electronic or computing devices through multimedia objects (e.g., images, videos, audios, etc.) rather than purely text commands. A user interface may allow users to interact with a social-networking system.

Generating a scrollable table by creating all the row or column instances and filling them with content at the beginning may constitute a significant cause of latency for complex and content-intensive applications, including, by way of example and not of limitation, those that need to display large tables of content that a user may scroll through. Computing devices may need to render a GUI for display that includes a table of content-filled cells. Latency may be detected when responding to GUI-related input (e.g., user interacting with the GUI to request a new display) and may increase as the GUI becomes larger and more complex.

### SUMMARY OF PARTICULAR EMBODIMENTS

Particular embodiments provide a robust framework for presenting a content-filled table with a resizable scrollbar. In particular embodiments, the framework allows a user to effectively scroll through a table in which there are a set number of cell instances that have been created and are reused as the user scrolls. Cell instances may be row instances or column instances. Cell instances may be incrementally buffered rather than loading all of the data at the outset. In particular embodiments the length of the resizable scrollbar may be determined and dynamically adjusted based on the dimensions of the cell instances (i.e., the heights of the row instances or the widths of the column instances).

The embodiments disclosed above are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g., system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed includes not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example network environment associated with a social-networking system.

FIG. 2A illustrates an example table.

FIG. 2B illustrates an example of incrementally buffering row instances in a table.

FIGS. 3A-3B illustrate an example of recycling a row instance in a table.

FIG. 4 illustrates an example table with a header row instance and columns.

FIG. 5 is a flowchart of illustrative steps for providing a table.

FIG. 6 is a flowchart illustrating an example method for providing a table.

FIG. 7 illustrates an example social graph.

FIG. 8 illustrates an example computer system.

### DESCRIPTION OF EXAMPLE EMBODIMENTS

### System Overview

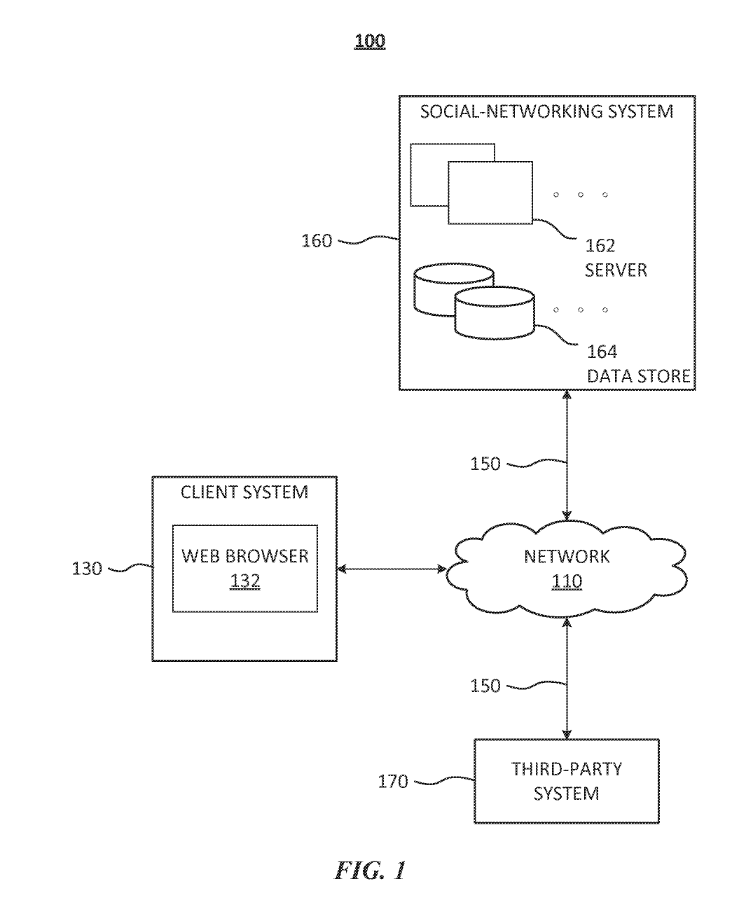

FIG. 1 illustrates an example network environment 100 associated with a social-networking system. Network environment 100 includes a client system 130, a social-networking system 160, and a third-party system 170 connected to each other by a network 110. Although FIG. 1 illustrates a particular arrangement of client system 130, social-networking system 160, third-party system 170, and network 110, this disclosure contemplates any suitable arrangement of client system 130, social-networking system 160, third-party system 170, and network 110. As an example and not by way of limitation, two or more of client system 130, social-networking system 160, and third-party system 170 may be connected to each other directly, bypassing network 110. As another example, two or more of client system 130, social-networking system 160, and third-party system 170 may be physically or logically co-located with each other in whole or in part. Moreover, although FIG. 1 illustrates a particular number of client systems 130, social-networking systems 160, third-party systems 170, and networks 110, this disclosure contemplates any suitable number of client systems 130, social-networking systems 160, third-party systems 170, and networks 110. As an example and not by way of limitation, network environment 100 may include multiple client system 130, social-networking systems 160, third-party systems 170, and networks 110.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Links 150 may connect client system 130, social-networking system 160, and third-party system 170 to communication network 110 or to each other. This disclosure contemplates any suitable links 150. In particular embodiments, one or more links 150 include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In particular embodiments, one or more links 150 each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout network environment 100. One or more first links 150 may differ in one or more respects from one or more second links 150.

In particular embodiments, client system 130 may be an electronic device including hardware, software, or embedded logic components or a combination of two or more such components and capable of carrying out the appropriate functionalities implemented or supported by client system 130. As an example and not by way of limitation, a client system 130 may include a computer system such as a desktop computer, notebook or laptop computer, netbook, a tablet computer, e-book reader, GPS device, camera, personal digital assistant (PDA), handheld electronic device, cellular telephone, smartphone, other suitable electronic device, or any suitable combination thereof. This disclosure contemplates any suitable client systems 130. A client system 130 may enable a network user at client system 130 to access network 110. A client system 130 may enable its user to communicate with other users at other client systems 130.

In particular embodiments, client system 130 may include a web browser 132, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client system 130 may enter a Uniform Resource Locator (URL) or other address directing the web browser 132 to a particular server (such as server 162, or a server associated with a third-party system 170), and the web browser 132 may generate a Hyper Text Transfer Protocol (HTTP) request and communicate the HTTP request to server. The server may accept the HTTP request and communicate to client system 130 one or more Hyper Text Markup Language (HTML) files responsive to the HTTP request. Client system 130 may render a webpage based on the HTML files from the server for presentation to the user. This disclosure contemplates any suitable webpage files. As an example and not by way of limitation, webpages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, social-networking system 160 may be a network-addressable computing system that can host an online social network. Social-networking system 160 may generate, store, receive, and send social-networking data, such as, for example, user-profile data, concept-profile data, social-graph information, or other suitable data related to the online social network. Social-networking system 160 may be accessed by the other components of network environment 100 either directly or via network 110. As an example and not by way of limitation, client system 130 may access social-networking system 160 using a web browser 132, or a native application associated with social-networking system 160 (e.g., a mobile social-networking application, a messaging application, another suitable application, or any combination thereof) either directly or via network 110. In particular embodiments, social-networking system 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular embodiments, each server 162 may include hardware, software, or embedded logic components or a combination of two or more such components for carrying out the appropriate functionalities implemented or supported by server 162. In particular embodiments, social-networking system 160 may include one or more data stores 164. Data stores 164 may be used to store various types of information. In particular embodiments, the information stored in data stores 164 may be organized according to specific data structures. In particular embodiments, each data store 164 may be a relational, columnar, correlation, or other suitable database. Although this disclosure describes or illustrates particular types of databases, this disclosure contemplates any suitable types of databases. Particular embodiments may provide interfaces that enable a client system 130, a social-networking system 160, or a third-party system 170 to manage, retrieve, modify, add, or delete, the information stored in data store 164.

In particular embodiments, social-networking system 160 may store one or more social graphs in one or more data stores 164. In particular embodiments, a social graph may include multiple nodes—which may include multiple user nodes (each corresponding to a particular user) or multiple concept nodes (each corresponding to a particular concept)—and multiple edges connecting the nodes. Social-networking system 160 may provide users of the online social network the ability to communicate and interact with other users. In particular embodiments, users may join the online social network via social-networking system 160 and then add connections (e.g., relationships) to a number of other users of social-networking system 160 to whom they want to be connected. Herein, the term “friend” may refer to any other user of social-networking system 160 with whom a user has formed a connection, association, or relationship via social-networking system 160.

In particular embodiments, social-networking system 160 may provide users with the ability to take actions on various types of items or objects, supported by social-networking system 160. As an example and not by way of limitation, the items and objects may include groups or social networks to which users of social-networking system 160 may belong, events or calendar entries in which a user might be interested, computer-based applications that a user may use, transactions that allow users to buy or sell items via the service, interactions with advertisements that a user may perform, or other suitable items or objects. A user may interact with anything that is capable of being represented in social-networking system 160 or by an external system of third-party system 170, which is separate from social-networking system 160 and coupled to social-networking system 160 via a network 110.

In particular embodiments, social-networking system 160 may be capable of linking a variety of entities. As an example and not by way of limitation, social-networking system 160 may enable users to interact with each other as well as receive content from third-party systems 170 or other entities, or to allow users to interact with these entities through an application programming interfaces (API) or other communication channels.

In particular embodiments, a third-party system 170 may include one or more types of servers, one or more data stores, one or more interfaces, including but not limited to APIs, one or more web services, one or more content sources, one or more networks, or any other suitable components, e.g., that servers may communicate with. A third-party system 170 may be operated by a different entity from an entity operating social-networking system 160. In particular embodiments, however, social-networking system 160 and third-party systems 170 may operate in conjunction with each other to provide social-networking services to users of social-networking system 160 or third-party systems 170. In this sense, social-networking system 160 may provide a platform, or backbone, which other systems, such as third-party systems 170, may use to provide social-networking services and functionality to users across the Internet.

In particular embodiments, a third-party system 170 may include a third-party content object provider. A third-party content object provider may include one or more sources of content objects, which may be communicated to a client system 130. As an example and not by way of limitation, content objects may include information regarding things or activities of interest to the user, such as, for example, movie show times, movie reviews, restaurant reviews, restaurant menus, product information and reviews, or other suitable information. As another example and not by way of limitation, content objects may include incentive content objects, such as coupons, discount tickets, gift certificates, or other suitable incentive objects.

In particular embodiments, social-networking system 160 also includes user-generated content objects, which may enhance a user's interactions with social-networking system 160. User-generated content may include anything a user can add, upload, send, or “post” to social-networking system 160. As an example and not by way of limitation, a user communicates posts to social-networking system 160 from a client system 130. Posts may include data such as status updates or other textual data, location information, photos, videos, links, music or other similar data or media. Content may also be added to social-networking system 160 by a third-party through a “communication channel,” such as a newsfeed or stream.

In particular embodiments, social-networking system 160 may include a variety of servers, sub-systems, programs, modules, logs, and data stores. In particular embodiments, social-networking system 160 may include one or more of the following: a web server, action logger, API-request server, relevance-and-ranking engine, content-object classifier, notification controller, action log, third-party-content-object-exposure log, inference module, authorization/privacy server, search module, advertisement-targeting module, user-interface module, user-profile store, connection store, third-party content store, or location store. Social-networking system 160 may also include suitable components such as network interfaces, security mechanisms, load balancers, failover servers, management-and-network-operations consoles, other suitable components, or any suitable combination thereof. In particular embodiments, social-networking system 160 may include one or more user-profile stores for storing user profiles. A user profile may include, for example, biographic information, demographic information, behavioral information, social information, or other types of descriptive information, such as work experience, educational history, hobbies or preferences, interests, affinities, or location. Interest information may include interests related to one or more categories. Categories may be general or specific. As an example and not by way of limitation, if a user “likes” an article about a brand of shoes the category may be the brand, or the general category of “shoes” or “clothing.” A connection store may be used for storing connection information about users. The connection information may indicate users who have similar or common work experience, group memberships, hobbies, educational history, or are in any way related or share common attributes. The connection information may also include user-defined connections between different users and content (both internal and external). A web server may be used for linking social-networking system 160 to one or more client systems 130 or one or more third-party system 170 via network 110. The web server may include a mail server or other messaging functionality for receiving and routing messages between social-networking system 160 and one or more client systems 130. An API-request server may allow a third-party system 170 to access information from social-networking system 160 by calling one or more APIs. An action logger may be used to receive communications from a web server about a user's actions on or off social-networking system 160. In conjunction with the action log, a third-party-content-object log may be maintained of user exposures to third-party-content objects. A notification controller may provide information regarding content objects to a client system 130. Information may be pushed to a client system 130 as notifications, or information may be pulled from client system 130 responsive to a request received from client system 130. Authorization servers may be used to enforce one or more privacy settings of the users of social-networking system 160. A privacy setting of a user determines how particular information associated with a user can be shared. The authorization server may allow users to opt in to or opt out of having their actions logged by social-networking system 160 or shared with other systems (e.g., third-party system 170), such as, for example, by setting appropriate privacy settings. Third-party-content-object stores may be used to store content objects received from third parties, such as a third-party system 170. Location stores may be used for storing location information received from client systems 130 associated with users. Advertisement-pricing modules may combine social information, the current time, location information, or other suitable information to provide relevant advertisements, in the form of notifications, to a user.

Particular embodiments provide a table including a plurality of cell instances and having a scrollbar with a resizable handle for display on client system 130. As used herein, “table” refers to a list of cell instances (e.g., any suitable number of cell instances oriented along an axis), a two-dimensional table of cell instances (e.g., any suitable number of cell instances oriented along two axes), a three-dimensional table of cell instances (e.g., any suitable number of cell instances oriented along three axes), any other suitable data structure, or any combination thereof. As an example and not by way of limitation, the table may be a messaging thread, a feed of stories, The table may include one or more scrollbars, each with a resizable handle. As an example and not by way of limitation, a table may have one scrollbar with a resizable handle, and the scrollbar may be vertical (i.e., scrolling up and down) or horizontal (i.e., scrolling left and right). As another example and not by way of limitation, a three-dimensional table may have three scrollbars with resizable handles, each oriented along an axis in three-dimensional space, the three axes perpendicular to each other. A cell instance may be a row instance (i.e., a plurality of row instances may collectively form a column) or a column instance (i.e., a plurality of column instances may collectively form a row). Tables are depicted and described herein as including a plurality of row instances, each oriented along a vertical axis; it will be understood, however, that this is for brevity and not by way of limitation. A table may include any suitable number of cell instances oriented along one, two, or three axes, and the table may have one, two, or three scrollbars with resizable handles, each oriented along a respective axis.

### Initial Table Structure & Loading

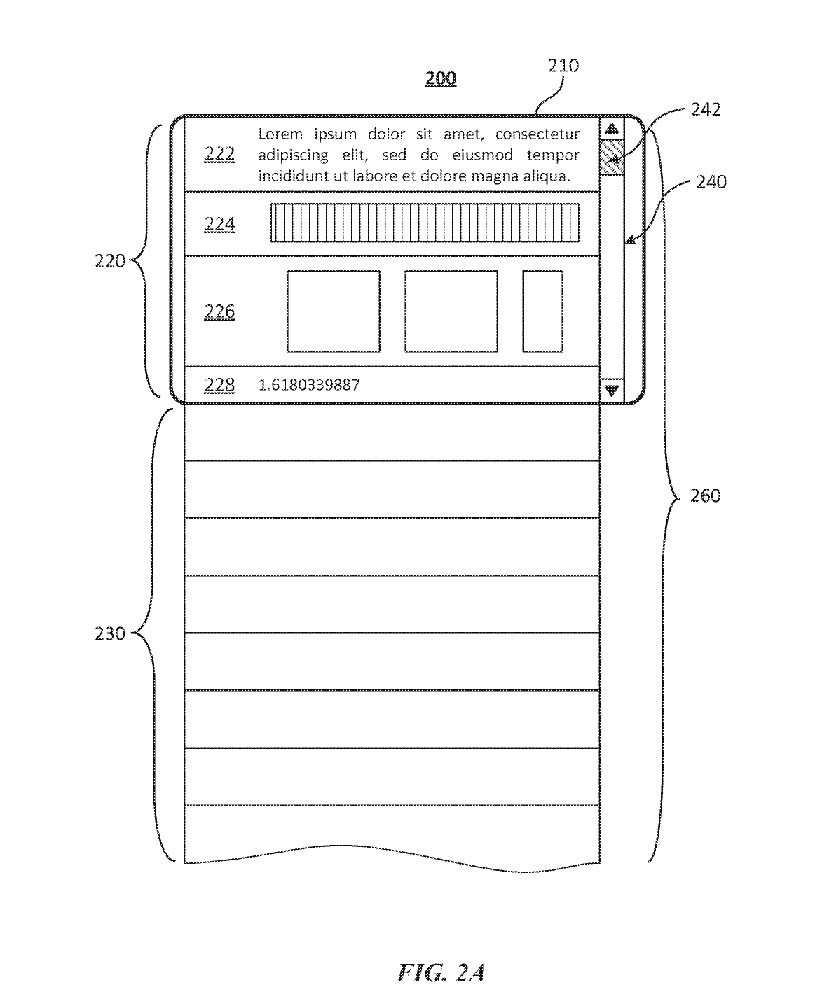

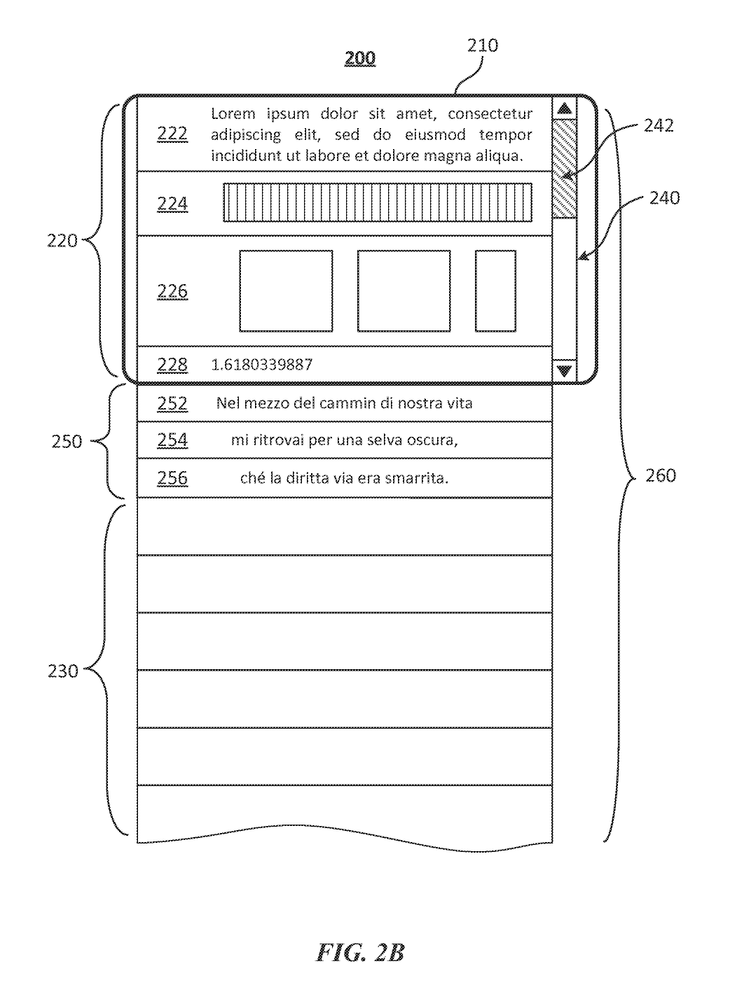

FIG. 2A illustrates an example table 200. In particular embodiments, table 200 may be rendered for display on client system 130 using any suitable application running on client system 130 (e.g., a browser). In particular embodiments, table 200 may be provided in displayable region 210. Displayable region 210 may correspond to the entire screen of client system 130 or a subregion of the screen (e.g., a particular window, frame, or area of a GUI presented on a screen of client system 130).

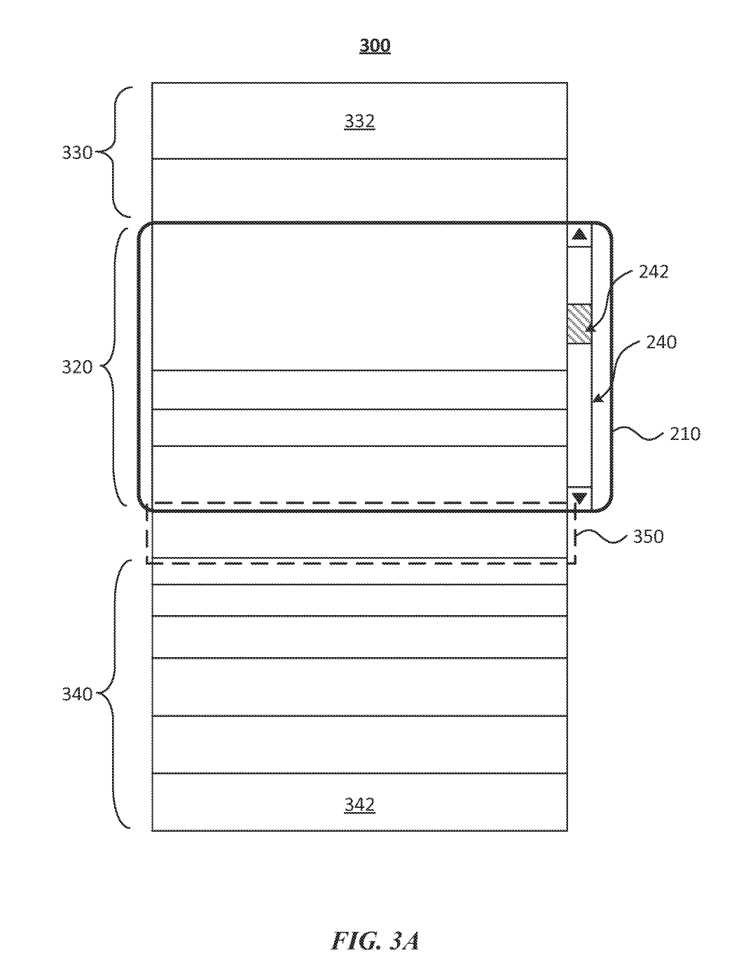

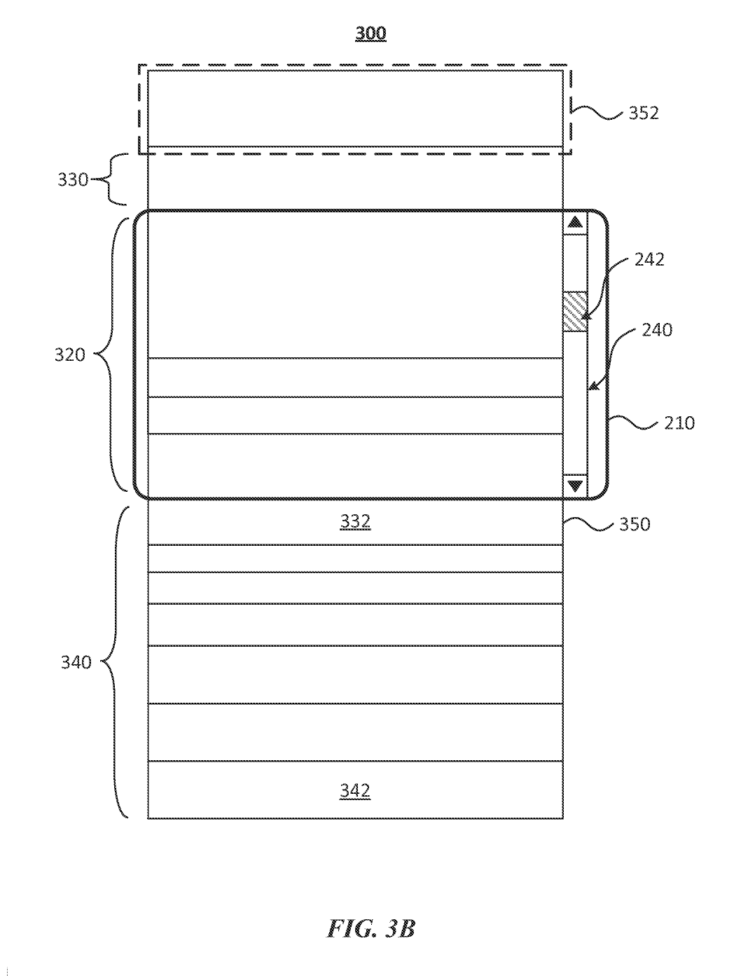

In particular embodiments, at least a portion of table 200 may be loaded in response to a received request to display table 200. Particular embodiments may provide an API to enable application developers to call API functions to create a table 200 for application content and to handle table navigation. Particular embodiments may be based on the REACT JAVASCRIPT library. Table 200 may include any suitable number of data cells, which are organized into rows, each row associated with a row position, which may be marked in table 200 by a row position indicator. Table 200 may have a total number of rows that exceeds the number of rows that may be displayed in displayable region 210. Client system 130 may generate table 200 by instantiating a number of row instances 260. Each row instance 260 may be an empty container than can be filled with content when “buffered.” Each row instance 260 may be recycled (i.e., the rendered content may be discarded) and reused (i.e. the row instance 260 may be assigned to a new row position and filled with newly-rendered content), as further discussed in connection with FIGS. 3A-3B. Instantiating row instances 260 may include allocating space in memory of client system 130 for each row instance 260. The total number of row instances 260 may depend on the amount of memory on client system 130 available for generating and displaying table 200. The total number of row instances 260 may include enough row instances to both fill displayable region 210 and provide a buffer (e.g., 16 row instances). The total number of row instances 260 may be fewer than the total number of rows of table 200.

When table 200 is first loaded, row instances 260 may include a first subset of row instances 220, which are buffered, and unbuffered row instances 230. As used herein, a row instance is “buffered” by assigning it to a row position (e.g., a row position within displayable region 210) and filling it with rendered content for display, the rendered content being associated with the row position. That is, a buffered row instance is filled with rendered content specific to the row position to which that buffered row instance is assigned. Whereas, as used herein, an unbuffered row instance is not yet assigned to a row position and is not filled with rendered content (i.e., empty). Rendered content may include any suitable text, images, media, any content retrievable by executing a callback function (e.g., a JAVASCRIPT callback function), any other suitable content, or any combination thereof. In particular embodiments, a particular range of buffered row instances may be collapsed (e.g., to a height of just a couple pixels each) and may be expanded to display further content. Particular embodiments may provide interactive row instance features by incorporating zero-height sub-rows.

Row instances 220 may fill displayable region 210. Each of the row instances 220 may be assigned to a row position within a range of row positions within displayable region 210. The particular range of row positions within displayable region 210 may depend on the height of the rendered content to be displayed at each row position. In table 200, the particular range of row positions within displayable region 210 may correspond to a range of row positions oriented at the top of table 200. In the example illustrated in FIG. 2A, row instances 220 includes row instances 222, 224, 226, and 228. Also as shown in FIG. 2A, only row instances 222, 224, 226, and 228, which are each assigned to a row position in the range of row positions within the displayable region 210, are filled with rendered content. In particular embodiments, when table 200 is initially generated, client system 130 buffers only the row instances necessary to fill the displayable region 210, which are shown in FIG. 2A as row instances 222, 224, 226, and 228. In this manner, client system 130 may preserve resources by buffering only the row instances that are currently viewable by a user at client system 130.

In particular embodiments, table 200 includes a scrollbar 240 (e.g., vertical scrollbar) that includes a resizable handle 242. Client system 130 may initially generate resizable handle 242 as having an initial size that is based on the total number of rows in table 200, as well as the dimensions of row instances 260 (e.g., the sum of the heights of the row instances). When client system 130 initially generates table 200, the actual heights of unbuffered row instances 230 may not be computed, as each of these unbuffered row instances 230 is empty (i.e., not filled with rendered content). Hence, client system 130 may assume a default height for each of unbuffered row instances 230, as shown in FIG. 2A. Client system 130 may compute a respective actual height of each row instance 220 based on the rendered content in each row instance. For example, as shown in FIG. 2A, the height of row instance 226 is greater than the height of row instance 228, because the rendered content in row instance 226 takes up more vertical space than the content rendered in row instance 228. Thus, the initial size (i.e., length) of resizable handle 242 may be determined based on (1) the total number of rows for table 200, (2) the actual heights of the row instances 220 (i.e., buffered row instances assigned to row positions within displayable region 210), and (3) default heights for the unbuffered row instances 230 (i.e., unbuffered row instances not yet assigned to row positions). The size of resizable handle 242 may be dynamically adjusted as actual heights are determined for more row instances. As described below in connection with FIG. 2B, unbuffered row instances 230 may be incrementally buffered, and heights of the newly-buffered row instances may be determined based on the rendered content in each.

### Incrementally Buffering Row Instances

FIG. 2B illustrates an example of incrementally buffering row instances in a table 200. As described above in connection with FIG. 2A, when client system 130 initially loads table 200, client system 130 may buffer only row instances 220, which are assigned to positions within displayable region 210, in order to decrease latency in provision of table 200. In particular embodiments, client system 130 may incrementally buffer sets of unbuffered row instances 230. In particular embodiments, row instances are buffered one at a time. If a viewing user at client system 130 does not immediately scroll or otherwise immediately navigate in the table using scrollbar 240 for at least a minimum predetermined period of time (e.g., 0.5 seconds), client system 130 may buffer a preset number of row instances. As illustrated in FIG. 2B, after a predetermined period of time has passed in which no user scroll input is received, client system 130 may buffer a second subset of row instances 250. As used herein, “user scroll input” refers to any user input received at client system 130, the user input manipulating scrollbar 240 in order to scroll up or down in table 200 (i.e., the user input requests one or more different row positions be displayed within displayable region 210) or to otherwise navigate to a new range of row positions in a table (e.g., by jumping from a first range of row positions to a second range of row positions in the table). Each row instance 250, shown as including row instances 252, 254, and 256 in FIG. 2B, may be assigned to a respective row position outside of displayable region 210 (i.e., above or below). Accordingly, the user may be able to scroll up or down in table 200 at a high frame rate without interruption to the user experience (e.g., viewing invalid data), as row instances 250 may be buffered and ready for display should the user scroll input cause one or more row positions to which one or more of row instances 250 are assigned to come into the range of row positions within displayable region 210. As an example and not by way of limitation, upon receipt of user input scrolling downward in table 200, row instances 252, 254 and 256 would be ready for immediate display to the user in displayable region 210. Once a row instance has been buffered, the row height and content may be retained (e.g., in memory of client system 130) in order to speed up content retrieval later if the user were to scroll back to a previous range of row positions after scrolling away (e.g., to a range of row positions above or below the previous range of row positions). It will be understood that row instances 250 are depicted as being assigned to positions below the range of positions within displayable region 210 for illustrative purposes and not by way of limitation and that row instances 250 may be assigned to row positions above displayable region 210, below displayable region 210, or both.

As a user scrolls through table 200, the total number of row instances 260 may remain constant, so, after client system 130 buffers row instances 250, the number of available unbuffered row instances 230 decreases, as illustrated in table 200. After another predetermined period of time passes with no user scroll input being received, client system 130 may buffer another set (i.e., a third number, not shown) of unbuffered row instances 230. This process may be repeated until all of row instances 260 are buffered (i.e., there are no remaining available unbuffered row instances 230).

When client system 130 buffers row instances 250, each row instance (i.e., row instances 252, 254, and 256) is filled with rendered content. Client system 130 may then determine a respective height for each of row instances 250. The length of the resizable handle 242 may then be dynamically updated based on the determined row heights for the newly-buffered row instances 250. As an example and not by way of limitation, client system 130 may use the newly-determined heights of row instances 252, 254, and 256 to determine an updated size of the resizable handle (i.e., based on the determined heights for row instances 250, determined heights for row instances 220, and default heights for unbuffered row instances 230). As another example and not by way of limitation, if the determined heights of row instances 252, 254, and 256 are shorter than the default heights, as shown in the illustrated example of FIG. 2B, client system 130 may determine an updated size (i.e., length) of resizable handle 242 that is greater than the initially-determined size of resizable handle 242. Client system 130 may then provide updated resizable handle 242 for display, the updated resizable handle 242 having the updated size.

In particular embodiments, each row position in table 200 may correspond to particular pixels on scrollbar 240. As heights are determined for newly-buffered rows, the pixel correspondence between row positions and scrollbar 240 may be updated. In particular embodiments, the user may request that the displayable region “jump” to a destination row position by selecting the corresponding pixels on scrollbar 240. Once the destination row position is determined, row instances may be buffered (if they have not already been buffered) for the destination row and for adjacent row positions (i.e., above the destination row position, below the destination row position, or both) in the new range of row positions within displayable region 210. In some embodiments, the range of rows to be included within displayable region 210 after a “jump” may be determined by establishing the destination row as the outer boundary of the updated range of row positions. As an example and not by way of limitation, if the range of row positions in displayable region 210 is 45-55 out of a total of 100 row positions, and the user “jumps” to destination row position 75, then the range of row positions for the updated displayable region 210 may be 65-75. In the same example, if the user instead “jumps” to destination row position 25, then the range of row positions for the updated displayable region 210 may be 25-35. This may reduce the need to recycle row instances (described in further detail below in connection with FIGS. 3A-3B) and preserve the largest number of buffered row instances. As an example and not by way of limitation, the range of row positions in displayable region 210 may be 45-55 out of 100 row positions, and rows 35-44 and 56-65 may be assigned to buffered row instances. In the same example, the user may “jump” to destination row position 60, and the updated range of row positions within displayable region 210 may then be 50-60. Because row positions 50-55 were in the range of row positions within displayable region 210 (i.e., already assigned to buffered row instances), and rows 56-65 are already assigned to buffered row instances, the updated range of row positions within displayable region 210 should be able to be displayed rapidly.

In particular embodiments, when user scroll input requests a “jump” to a destination row position, client system 130 may set a marker, which may not be visible to a viewing user, in displayable region 210. Client system 130 may use the marker to determine how to size buffered row instances assigned to row positions now within displayable region 210 in the situation in which rendered content in the row instances is taller than the default height assumed for row positions to which no buffered row instance is assigned. In particular embodiments, the marker may be set based on the requested destination row position. In particular embodiments, user scroll input requesting a “jump” may be a selection of a particular pixel on scrollbar 240, and the marker may be set based on a corresponding pixel in table 200. As an example and not by way of limitation, user scroll input may select a pixel, and client system 130 may buffer row instances for the row positions that fall at and around (e.g., above, below, or both) the marker set at the corresponding pixel in table 200. In the same example, if a buffered row instance assigned to a row position above the marker is filled with rendered content that is taller than the default size, client system 130 may expand the row instance upward. In the same example, if a buffered row instance assigned to a row position below the marker is filled with rendered content that is taller than the default size, client system 130 may expand the row instance downward. In this manner, client system 130 ensures that the new range of row positions within displayable region 210 is centered at the user-selected location (i.e., the destination row location or the corresponding pixel in table 200). In another example, if the user scroll input is a selection of a pixel at or near the bottom of table 200, buffered row instances assigned to row positions within the new range of row positions in displayable region 210 may be expanded upwards (i.e., the bottom boundary of table 200 may be fixed). Similarly, if the user scroll input is a selection of a pixel at or near the top of table 200 buffered row instances assigned to row positions within the new range of row positions in displayable region 210 may be expanded downwards (i.e., the top boundary of table 200 may be fixed). In particular embodiments where resizing causes a row position to which a buffered row instance is assigned to fall outside of displayable region 210, the buffered row instance is retained in a buffer (e.g., like row instances 250).

In particular embodiments, one or more new row positions of table 200 may be created, and a row instance may be assigned to each new row position and filled with new, rendered content. As an example and not by way of limitation, table 200 may be a messaging thread, and rows of table 200 may provide messages (e.g., as part of a conversation between two or more users of social-networking system 160). When table 200 is initially loaded, as described above in connection with FIG. 2A, the particular range of row positions within displayable region 210 may be determined based on the recency of the content associated with each row position. As an example and not by way of limitation, row instances assigned to the row positions within displayable region 210 may be filled with rendered content that was added (e.g., inputted by a user via a native messaging application running on client system 130) most recently (i.e., relative to the content associated with other row positions of table 200). The range of row positions within displayable region 210 when table 200 is initially loaded may be a range of row positions oriented at the bottom of table 200. As an example and not by way of limitation, scrolling upward through table 200 may, effectively, be scrolling backwards in time through messages. A user may input content (e.g., text or media data) using, as an example and not by way of limitation, a native messaging application running on client system 130. As the user types or otherwise inputs new content, table 200 may create one or more new row positions below the previous bottom boundary of table 200 (i.e., the bottom boundary may be updated based on the new row positions). Table 200 may buffer one or more row instances by assigning each to one of the new row positions and filling the one or more row instances with the new content. As soon as the user submits the new content (e.g., selects a send command at the messaging application), the range of row positions within displayable region 210 may be dynamically updated to include the new row positions (i.e., to display the recently-added message).

Although table 200 is described in a particular manner herein, table 200 may be represented in any suitable manner and generated using any suitable method or technique. Although table 200 is depicted and described as having a particular number of row instances, it will be understood that this is for illustrative purposes, not by way of limitation, and that table 200 may have any suitable number of row instances. It will further be understood that table 200 is depicted as being made of up of row instances and a vertical scrollbar, this is for illustrative purposes, not by way of limitation, and that table 200 may be made up of any suitable number of column instances and may have a horizontal scrollbar. As an example and not by way of limitation, table 200 may be generated by instantiating column instances, and the length of a resizable handle of a horizontal scrollbar may be determined based on the widths of the column instances.

Although this disclosure describes and illustrates particular embodiments of FIGS. 2A-2B as being implemented by client system 130, this disclosure contemplates any suitable embodiments of FIGS. 2A-2B as being implemented by any suitable platform or system. As an example, and not by way of limitation, particular embodiments of FIGS. 2A-2B may be implemented by social-networking system 160. Furthermore, although this disclosure describes and illustrates particular components, devices, or systems carrying out particular steps of the method of FIGS. 2A-2B, this disclosure contemplates any suitable combination of any suitable components, devices, or systems carrying out any suitable steps of the method of FIGS. 2A-2B.

### Recycling Row Instances

FIGS. 3A-3B illustrate an example of recycling a row instance 345 in a table 300. In FIG. 3A, table 300 is shown as including buffered row instances 320, which are assigned to row positions within displayable region 210; buffered row instances 330, which are assigned to row positions above displayable region 210; and buffered row instances 340, which are assigned to row positions below displayable region 210. As a user scrolls through table 300 (i.e., user scroll input is received), the range of row positions in displayable region 210 may approach one or more row positions to which no buffered row instances are assigned. As described above, once a maximum number of row instances have been buffered, the number of buffered row instances may not increase as the user scrolls. Thus, in table 400, the total number of buffered row instances is shown as the sum of the respective number of row instances 320, 330, and 340, and this total number of buffered row instances may not change. Rather, each buffered row instance 320, 330, and 340 in table 400 may be recycled, by discarding the rendered content in the row instance, and thereby freeing it up for reuse (i.e., by assigning a new row position and filling the row instance with newly-rendered content).

In particular embodiments, in response to user scroll input, displayable region 210 may come within a predetermined distance of a row position to which no buffered row instance is assigned, and client system 130 may recycle a buffered row instance (e.g., a buffered row instance assigned to a row position above or below displayable region 210). In particular embodiments, client system 130 may initiate recycling of a buffered row instance when, in response to user scroll input, a distance between displayable region 210 and a particular buffered row instance exceeds a predetermined threshold. Client system 130 may then implement an algorithm to determine the buffered row instance assigned to a row position farthest from a boundary (i.e., an upper or lower boundary) of displayable region 210. The farthest buffered row instance may then be recycled by assigning it to a “closer” row position (with respect to the current range of row positions within the displayable region 210) to which no buffered row instance was assigned.

In the illustrated example of FIG. 3A, table 300 includes row position 350, to which no row instance of buffered row instances 320, 330, or 340 is assigned. Displayable region 210 is depicted as including a range of row positions, to which row instances 320 are assigned, the lower boundary of the range of row instances within displayable region 210 being adjacent to row position 350. As described above, in particular embodiments, client system 130 may initiate the recycling of a buffered row instance based any suitable boundary of displayable region 210 being any suitable distance from a row position to which no buffered row instance is assigned. As an example and not by way of limitation, client system 130 may initiate recycling of a row instance when the range of row positions within the displayable region 210 comes within 5 row positions of a row position to which no row instance is assigned. Once this proximity condition has been satisfied, client system 130 may determine a buffered row instance to recycle. The particular row instance to recycle may be determined based on distances between a boundary of displayable region 210 and buffered row instances of table 400. In particular embodiments, the direction of received user scroll input may be taken into account when determining which buffered row instance to recycle. The direction of received user input may also be used to determine which boundary of displayable region 210 should be used in determining the farthest row instance. As an example and not by way of limitation, if the range of row positions within displayable region 210 in table 400 were the result of a received user input requesting a downward scroll, then client system 130 may use the upper boundary of displayable region 210 to determine that buffered row instance 332, which is assigned to a row position above displayable region 210, is farthest from displayable region 210. Conversely, if the range of row positions within displayable region 210 in table 400 were the result of a received user input requesting an upward scroll, then client system 130 may use the lower boundary of displayable region 210 to determine that buffered row instance 342, which is assigned to a row position below displayable region 210, is farthest from displayable region 210. Thus, client system 130 may select a row instance to recycle based on the row instance being assigned to the farthest row position in the opposite direction of the last-received user scroll input. In particular embodiments, if client system 130 determines to recycle more than one buffered row instance, client system 130 may select, as an example and not by way of limitation, buffered row instance 342 and buffered row instance 332 to recycle (i.e., the row instance farthest above a top boundary of displayable region 210 and the row instance farthest below a bottom boundary of displayable region 210).

In FIG. 3B, row instance 332 of table 300 has been recycled. That is, row instance 332 has been reassigned to row position 350 and filled with rendered content associated with row position 350. As shown, because the total number of buffered row instances does not change, there is now no row instance assigned to row position 352, to which row instance 332 was previously assigned. In the illustrated example of FIG. 3B, the range of row positions within displayable region 210 may have been the result of a user scroll input requesting a downward scroll. Hence, row instance 332, as shown in FIG. 3A, would have been the buffered row instance farthest from the upper boundary of displayable region 210 in the opposite direction (i.e., upward) of the last-received user scroll input (i.e., downward).

Although table 300 is described in a particular manner herein, table 300 may be represented in any suitable manner and generated using any suitable method or technique. Although table 300 is depicted and described as having a particular number of row instances, it will be understood that this is for illustrative purposes, not by way of limitation, and that table 300 may have any suitable number of row instances. It will further be understood that table 300 is depicted as being made of up of row instances and a vertical scrollbar, this is for illustrative purposes, not by way of limitation, and that table 300 may be made up of any suitable number of column instances and may have a horizontal scrollbar. As an example and not by way of limitation, a buffered column instance of table 300 may be recycled by reassigning the buffered column instance to a new column position and filling it with content for the column position.

Although this disclosure describes and illustrates particular embodiments of FIGS. 3A-3B as being implemented by client system 130, this disclosure contemplates any suitable embodiments of FIGS. 3A-3B as being implemented by any suitable platform or system. As an example, and not by way of limitation, particular embodiments of FIGS. 3A-3B may be implemented by social-networking system 160. Furthermore, although this disclosure describes and illustrates particular components, devices, or systems carrying out particular steps of the method of FIGS. 3A-3B, this disclosure contemplates any suitable combination of any suitable components, devices, or systems carrying out any suitable steps of the method of FIGS. 3A-3B.

### Header and Columns

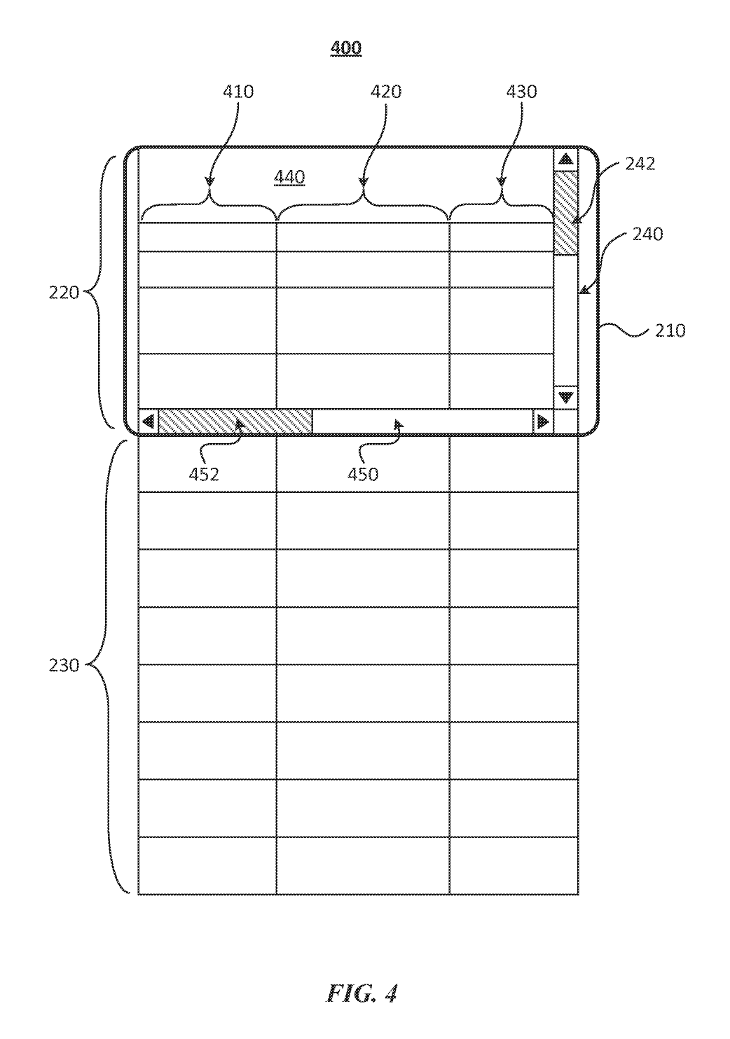

FIG. 4 illustrates an example table 400 with a header row instance 440 and columns 410, 420, and 430. In particular embodiments, table 400 may include a header row instance 440, which may be fixable. For the purposes of this disclosure, “fixable” refers to being capable of remaining visible (i.e., within displayable region 210) even when user scroll input (i.e., manipulating resizable handle 242 for scrollbar 240) requests a change in one or more of the row positions to be provided within displayable region 210. In other words, header 440 may be frozen in place in displayable region 210 and may be visible to the user even if the user scrolls away (e.g., downward) from the header row instance 440. In particular embodiments, table 400 may include a fixable footer row instance (not shown), which may remain visible at the bottom of table 400. In particular embodiments, one or more of the row instances of table 400 may be fixable. Table 400 may include first subset of row instances 220 and unbuffered row instances 230. In particular embodiments, first subset of row instances 220 and unbuffered row instances 230 may be divided into a plurality of columns, for example, columns 410, 420, and 430. Columns 410, 420, and 430, or any combination thereof, may also be fixable. Although table 400 is depicted as having columns 410, 420, and 430, this is merely illustrative, and table 400 may include any suitable number of columns. Table 400 may also include a resizable handle 452 for horizontal scrollbar 450, the size (i.e., length) of which may be based on the number and dimension (i.e., width) of column instances of table 400. In particular embodiments, each of columns 410, 420, and 430 may be specified as having a flexible width. That is, the width of each column may be automatically adjusted to fit a specified number of columns 410, 420, and 430 in displayable region 210. The width of each column may also be set to automatically expand or contract to fit the content rendered in cells of the column.

Although table 400 is described in a particular manner herein, table 400 may be represented in any suitable manner and generated using any suitable method or technique. Although table 400 is depicted and described as having a particular number of row instances and a particular number of columns, it will be understood that this is merely illustrative and that table 400 may have any suitable number of row instances and any suitable number of columns. In particular embodiments, table 400 may include any suitable number of cells, which may be organized in any suitable numbers of rows, columns, or both.

Although this disclosure describes and illustrates particular embodiments of FIG. 4 as being implemented by client system 130, this disclosure contemplates any suitable embodiments of FIG. 4 as being implemented by any suitable platform or system. As an example, and not by way of limitation, particular embodiments of FIG. 4 may be implemented by social-networking system 160. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

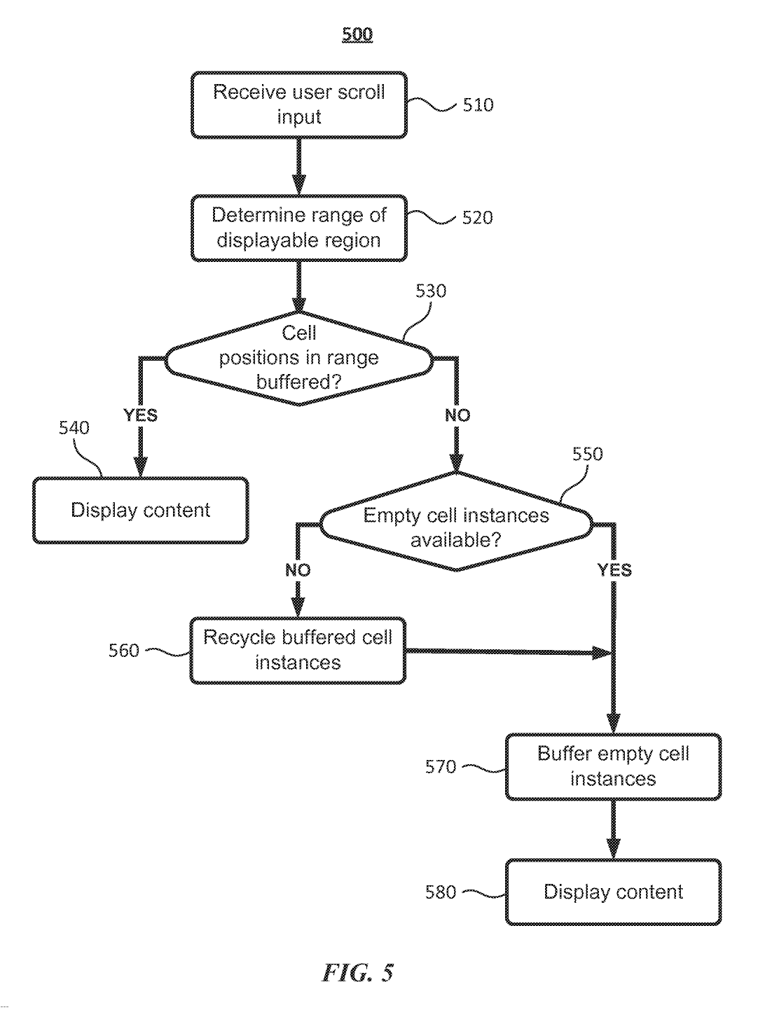

FIG. 5 is a flowchart 500 of illustrative steps for providing a table. In particular embodiments, the steps of flowchart 500 may be implemented by client system 130. In particular embodiments, the steps of flowchart 500 may be implemented in order to provide a table, which may correspond to, as an example and not by way of limitation, table 200 of FIGS. 2A-2B. At step 510, client system 130 receives user scroll input, which may be, as an example and not by way of limitation, scrolling up or down or jumping to a new range of cell positions in table 200. Cell positions may be row positions, which may be oriented along a first axis (e.g., vertical axis), or column positions, which may be oriented along a second axis (e.g., horizontal axis). In response to the received user scroll input, at step 520, client system 130 determines a new range of cell positions within displayable region 210. The new range of cell positions within displayable region 210 may be the same as the previously-provided range of cell positions (i.e., before user scroll input is received at step 510) or at least one cell position of the new range of cell positions may differ from those of the previously-provided range of cell positions. The new range of cell positions within displayable region 210 may be determined based on the user scroll input received at step 510. As an example and not by way of limitation, if the user scroll input requests a large scroll, the new range of cell positions may include a new set of cell positions, none of which was part of the previously-provided range of cell positions; whereas, if the user scroll input only requests a small scroll, one or more of the cell positions in the new range of cell positions may be the same as those in a previously-provided range of cell positions.

After the range of cell positions within displayable region 210 has been determined, client system 130 may proceed to step 530 and determine whether cell instances have been buffered for each of the cell positions in the range determined at step 520. If cell instances have been buffered (i.e., a cell instance has been assigned to each of the cell positions within the range of displayable region 210 and filled with rendered content), then client system 130 may proceed to step 540 and display the rendered content. If cell instances have not been buffered (i.e., no cell instance has been assigned to at least one of the cell positions within the range of displayable region 210) for at least one of the cell positions in the range determined at step 520, then client system 130 may determine whether any empty cell instances (e.g., unbuffered cell instances 230) are available for buffering at step 550. If an empty cell instances are not available for the cell positions in the range determined at step 520, then client system 130 may proceed to step 560 and recycle buffered cell instances. As an example and not by way of limitation, client system 130 may determine at step 530 that no cell instance has been buffered for one cell position in the range determined at step 520 and that no empty cell instance is available; client system 130 may then reuse one buffered cell instance (i.e., a cell instance that it assigned to a different cell position outside of displayable region 210) by reassigning the cell instance to the one cell position and rendering content for display in the cell instance. Recycling buffered cell instances is described in more detail above in connection with FIGS. 3A-3B. After buffered cell instances are recycled in step 560, client system 130 may proceed to step 570 to buffer the recycled cell instances and then display the rendered content in step 580. If empty cell instances are available for each of the cell positions in the range determined at step 520, then client system 130 may proceed directly to step 570 and buffer the empty cell instances by assigning each to a cell position in the range determined at step 520 and rendering content for display in each empty cell instance. After cell instances are buffered for each cell position in the range determined at step 520, client system 130 may proceed to step 580 and display the rendered content.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

### Method Flowchart

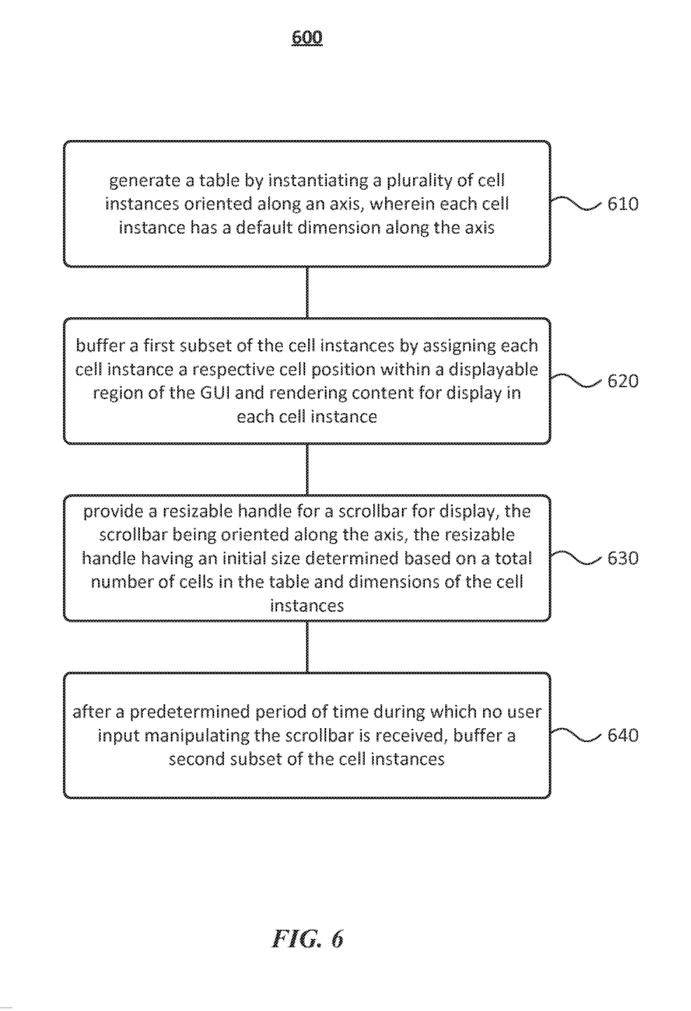

FIG. 6 is a flowchart illustrating an example method 600 for providing a table. The method may begin at step 610, where a table is generated by instantiating a plurality of cell instances, the cell instances being oriented along an axis, and each of the cell instances having a default dimension along the axis. At step 620, a first subset of the cell instances is buffered by assigning each cell instance of the first subset a respective cell position within a displayable region and by rendering content for display in each cell instance of the first subset. At step 630, a resizable handle for a scrollbar is provided for display, the scrollbar being oriented along the axis, the resizable handle having an initial size determined based on a total number of cells in the table and dimensions of the cell instances, and the dimensions including dimensions of the cell instances in the first subset and dimensions of unbuffered ones of the cell instances. At step 640, after a predetermined period of time during which no user input manipulating the scrollbar is received, a second subset of the cell instances is buffered. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for providing a table, including the particular steps of the method of FIG. 6, this disclosure contemplates any suitable method for providing a table, including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

### Social Graphs

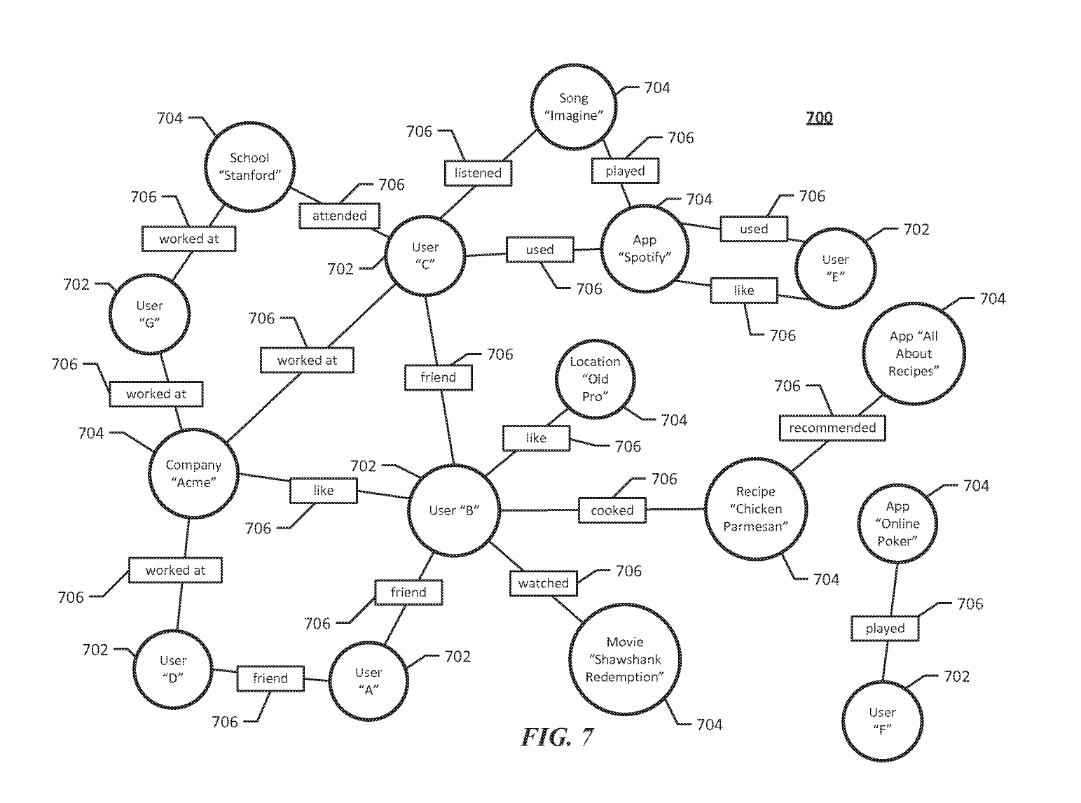

FIG. 7 illustrates example social graph 700. In particular embodiments, social-networking system 160 may store one or more social graphs 700 in one or more data stores. In particular embodiments, social graph 700 may include multiple nodes—which may include multiple user nodes 702 or multiple concept nodes 704—and multiple edges 706 connecting the nodes. Example social graph 700 illustrated in FIG. 7 is shown, for didactic purposes, in a two-dimensional visual map representation. In particular embodiments, a social-networking system 160, client system 130, or third-party system 170 may access social graph 700 and related social-graph information for suitable applications. The nodes and edges of social graph 700 may be stored as data objects, for example, in a data store (such as a social-graph database). Such a data store may include one or more searchable or queryable indexes of nodes or edges of social graph 700.

In particular embodiments, a user node 702 may correspond to a user of social-networking system 160. As an example and not by way of limitation, a user may be an individual (human user), an entity (e.g., an enterprise, business, or third-party application), or a group (e.g., of individuals or entities) that interacts or communicates with or over social-networking system 160. In particular embodiments, when a user registers for an account with social-networking system 160, social-networking system 160 may create a user node 702 corresponding to the user, and store the user node 702 in one or more data stores. Users and user nodes 702 described herein may, where appropriate, refer to registered users and user nodes 702 associated with registered users. In addition or as an alternative, users and user nodes 702 described herein may, where appropriate, refer to users that have not registered with social-networking system 160. In particular embodiments, a user node 702 may be associated with information provided by a user or information gathered by various systems, including social-networking system 160. As an example and not by way of limitation, a user may provide his or her name, profile picture, contact information, birth date, sex, marital status, family status, employment, education background, preferences, interests, or other demographic information. In particular embodiments, a user node 702 may be associated with one or more data objects corresponding to information associated with a user. In particular embodiments, a user node 702 may correspond to one or more webpages.

In particular embodiments, a concept node 704 may correspond to a concept. As an example and not by way of limitation, a concept may correspond to a place (such as, for example, a movie theater, restaurant, landmark, or city); a website (such as, for example, a website associated with social-network system 160 or a third-party website associated with a web-application server); an entity (such as, for example, a person, business, group, sports team, or celebrity); a resource (such as, for example, an audio file, video file, digital photo, text file, structured document, or application) which may be located within social-networking system 160 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 704 may be associated with information of a concept provided by a user or information gathered by various systems, including social-networking system 160. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 704 may be associated with one or more data objects corresponding to information associated with concept node 704. In particular embodiments, a concept node 704 may correspond to one or more webpages.

In particular embodiments, a node in social graph 700 may represent or be represented by a webpage (which may be referred to as a “profile page”). Profile pages may be hosted by or accessible to social-networking system 160. Profile pages may also be hosted on third-party websites associated with a third-party server 170. As an example and not by way of limitation, a profile page corresponding to a particular external webpage may be the particular external webpage and the profile page may correspond to a particular concept node 704. Profile pages may be viewable by all or a selected subset of other users. As an example and not by way of limitation, a user node 702 may have a corresponding user-profile page in which the corresponding user may add content, make declarations, or otherwise express himself or herself. As another example and not by way of limitation, a concept node 704 may have a corresponding concept-profile page in which one or more users may add content, make declarations, or express themselves, particularly in relation to the concept corresponding to concept node 704.

In particular embodiments, a concept node 704 may represent a third-party webpage or resource hosted by a third-party system 170. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system 130 to send to social-networking system 160 a message indicating the user's action. In response to the message, social-networking system 160 may create an edge (e.g., a check-in-type edge) between a user node 702 corresponding to the user and a concept node 704 corresponding to the third-party webpage or resource and store edge 706 in one or more data stores.

In particular embodiments, a pair of nodes in social graph 700 may be connected to each other by one or more edges 706. An edge 706 connecting a pair of nodes may represent a relationship between the pair of nodes. In particular embodiments, an edge 706 may include or represent one or more data objects or attributes corresponding to the relationship between a pair of nodes. As an example and not by way of limitation, a first user may indicate that a second user is a “friend” of the first user. In response to this indication, social-networking system 160 may send a “friend request” to the second user. If the second user confirms the “friend request,” social-networking system 160 may create an edge 706 connecting the first user's user node 702 to the second user's user node 702 in social graph 700 and store edge 706 as social-graph information in one or more of data stores 164. In the example of FIG. 7, social graph 700 includes an edge 706 indicating a friend relation between user nodes 702 of user “A” and user “B” and an edge indicating a friend relation between user nodes 702 of user “C” and user “B.” Although this disclosure describes or illustrates particular edges 706 with particular attributes connecting particular user nodes 702, this disclosure contemplates any suitable edges 706 with any suitable attributes connecting user nodes 702. As an example and not by way of limitation, an edge 706 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 700 by one or more edges 706.

In particular embodiments, an edge 706 between a user node 702 and a concept node 704 may represent a particular action or activity performed by a user associated with user node 702 toward a concept associated with a concept node 704. As an example and not by way of limitation, as illustrated in FIG. 7, a user may “like,” “attended,” “played,” “listened,” “cooked,” “worked at,” or “watched” a concept, each of which may correspond to an edge type or subtype. A concept-profile page corresponding to a concept node 704 may include, for example, a selectable “check in” icon (such as, for example, a clickable “check in” icon) or a selectable “add to favorites” icon. Similarly, after a user clicks these icons, social-networking system 160 may create a “favorite” edge or a “check in” edge in response to a user's action corresponding to a respective action. As another example and not by way of limitation, a user (user “C”) may listen to a particular song (“Imagine”) using a particular application (SPOTIFY, which is an online music application). In this case, social-networking system 160 may create a “listened” edge 706 and a “used” edge (as illustrated in FIG. 7) between user nodes 702 corresponding to the user and concept nodes 704 corresponding to the song and application to indicate that the user listened to the song and used the application. Moreover, social-networking system 160 may create a “played” edge 706 (as illustrated in FIG. 7) between concept nodes 704 corresponding to the song and the application to indicate that the particular song was played by the particular application. In this case, “played” edge 706 corresponds to an action performed by an external application (SPOTIFY) on an external audio file (the song “Imagine”). Although this disclosure describes particular edges 706 with particular attributes connecting user nodes 702 and concept nodes 704, this disclosure contemplates any suitable edges 706 with any suitable attributes connecting user nodes 702 and concept nodes 704. Moreover, although this disclosure describes edges between a user node 702 and a concept node 704 representing a single relationship, this disclosure contemplates edges between a user node 702 and a concept node 704 representing one or more relationships. As an example and not by way of limitation, an edge 706 may represent both that a user likes and has used at a particular concept. Alternatively, another edge 706 may represent each type of relationship (or multiples of a single relationship) between a user node 702 and a concept node 704 (as illustrated in FIG. 7 between user node 702 for user “E” and concept node 704 for “SPOTIFY”).

In particular embodiments, social-networking system 160 may create an edge 706 between a user node 702 and a concept node 704 in social graph 700. As an example and not by way of limitation, a user viewing a concept-profile page (such as, for example, by using a web browser or a special-purpose application hosted by the user's client system 130) may indicate that he or she likes the concept represented by the concept node 704 by clicking or selecting a “Like” icon, which may cause the user's client system 130 to send to social-networking system 160 a message indicating the user's liking of the concept associated with the concept-profile page. In response to the message, social-networking system 160 may create an edge 706 between user node 702 associated with the user and concept node 704, as illustrated by “like” edge 706 between the user and concept node 704. In particular embodiments, social-networking system 160 may store an edge 706 in one or more data stores. In particular embodiments, an edge 706 may be automatically formed by social-networking system 160 in response to a particular user action. As an example and not by way of limitation, if a first user uploads a picture, watches a movie, or listens to a song, an edge 706 may be formed between user node 702 corresponding to the first user and concept nodes 704 corresponding to those concepts. Although this disclosure describes forming particular edges 706 in particular manners, this disclosure contemplates forming any suitable edges 706 in any suitable manner.

### Social Graph Affinity and Coefficient

In particular embodiments, social-networking system 160 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 170 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system 160 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system 160 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system 160 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system 160 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system 160 may calculate a coefficient based on a user's actions. Social-networking system 160 may monitor such actions on the online social network, on a third-party system 170, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system 160 may calculate a coefficient based on the user's actions with particular types of content. The content may be associated with the online social network, a third-party system 170, or another suitable system. The content may include users, profile pages, posts, news stories, headlines, instant messages, chat room conversations, emails, advertisements, pictures, video, music, other suitable objects, or any combination thereof. Social-networking system 160 may analyze a user's actions to determine whether one or more of the actions indicate an affinity for subject matter, content, other users, and so forth. As an example and not by way of limitation, if a user may make frequently posts content related to “coffee” or variants thereof, social-networking system 160 may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system 160 may calculate a coefficient based on the type of relationship between particular objects. Referencing the social graph 700, social-networking system 160 may analyze the number and/or type of edges 706 connecting particular user nodes 702 and concept nodes 704 when calculating a coefficient. As an example and not by way of limitation, user nodes 702 that are connected by a spouse-type edge (representing that the two users are married) may be assigned a higher coefficient than a user nodes 702 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social-networking system 160 may determine that the user has a higher coefficient with respect to the first photo than the second photo because having a tagged-in-type relationship with content may be assigned a higher weight and/or rating than having a like-type relationship with content. In particular embodiments, social-networking system 160 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system 160 may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 700. As an example and not by way of limitation, social-graph entities that are closer in the social graph 700 (i.e., fewer degrees of separation) may have a higher coefficient than entities that are further apart in the social graph 700.

In particular embodiments, social-networking system 160 may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system 130 of the user). A first user may be more interested in other users or concepts that are closer to the first user. As an example and not by way of limitation, if a user is one mile from an airport and two miles from a gas station, social-networking system 160 may determine that the user has a higher coefficient for the airport than the gas station based on the proximity of the airport to the user.

In particular embodiments, social-networking system 160 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system 160 may provide information that is relevant to user's interests and current circumstances, increasing the likelihood that they will find such information of interest. In particular embodiments, social-networking system 160 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system 160 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system 160 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 170 (e.g., via an API or other communication channel), or from another suitable system. In response to the request, social-networking system 160 may calculate the coefficient (or access the coefficient information if it has previously been calculated and stored). In particular embodiments, social-networking system 160 may measure an affinity with respect to a particular process. Different processes (both internal and external to the online social network) may request a coefficient for a particular object or set of objects. Social-networking system 160 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Systems and Methods

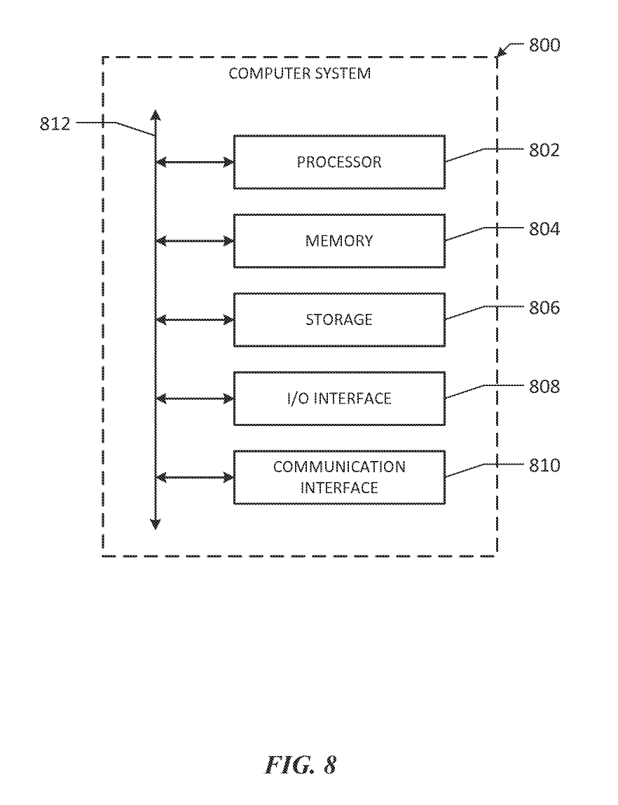

FIG. 8 illustrates an example computer system 800. In particular embodiments, one or more computer systems 800 perform one or more steps of one or more methods described or illustrated herein. In particular embodiments, one or more computer systems 800 provide functionality described or illustrated herein. In particular embodiments, software running on one or more computer systems 800 performs one or more steps of one or more methods described or illustrated herein or provides functionality described or illustrated herein. Particular embodiments include one or more portions of one or more computer systems 800. Herein, reference to a computer system may encompass a computing device, and vice versa, where appropriate. Moreover, reference to a computer system may encompass one or more computer systems, where appropriate.

This disclosure contemplates any suitable number of computer systems 800. This disclosure contemplates computer system 800 taking any suitable physical form. As example and not by way of limitation, computer system 800 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 800 may include one or more computer systems 800; be unitary or distributed; span multiple locations; span multiple machines; span multiple data centers; or reside in a cloud, which may include one or more cloud components in one or more networks. Where appropriate, one or more computer systems 800 may perform without substantial spatial or temporal limitation one or more steps of one or more methods described or illustrated herein. As an example and not by way of limitation, one or more computer systems 800 may perform in real time or in batch mode one or more steps of one or more methods described or illustrated herein. One or more computer systems 800 may perform at different times or at different locations one or more steps of one or more methods described or illustrated herein, where appropriate.

In particular embodiments, computer system 800 includes a processor 802, memory 804, storage 806, an input/output (I/O) interface 808, a communication interface 810, and a bus 812. Although this disclosure describes and illustrates a particular computer system having a particular number of particular components in a particular arrangement, this disclosure contemplates any suitable computer system having any suitable number of any suitable components in any suitable arrangement.

In particular embodiments, processor 802 includes hardware for executing instructions, such as those making up a computer program. As an example and not by way of limitation, to execute instructions, processor 802 may retrieve (or fetch) the instructions from an internal register, an internal cache, memory 804, or storage 806; decode and execute them; and then write one or more results to an internal register, an internal cache, memory 804, or storage 806. In particular embodiments, processor 802 may include one or more internal caches for data, instructions, or addresses. This disclosure contemplates processor 802 including any suitable number of any suitable internal caches, where appropriate. As an example and not by way of limitation, processor 802 may include one or more instruction caches, one or more data caches, and one or more translation lookaside buffers (TLBs). Instructions in the instruction caches may be copies of instructions in memory 804 or storage 806, and the instruction caches may speed up retrieval of those instructions by processor 802. Data in the data caches may be copies of data in memory 804 or storage 806 for instructions executing at processor 802 to operate on; the results of previous instructions executed at processor 802 for access by subsequent instructions executing at processor 802 or for writing to memory 804 or storage 806; or other suitable data. The data caches may speed up read or write operations by processor 802. The TLBs may speed up virtual-address translation for processor 802. In particular embodiments, processor 802 may include one or more internal registers for data, instructions, or addresses. This disclosure contemplates processor 802 including any suitable number of any suitable internal registers, where appropriate. Where appropriate, processor 802 may include one or more arithmetic logic units (ALUs); be a multi-core processor; or include one or more processors 802. Although this disclosure describes and illustrates a particular processor, this disclosure contemplates any suitable processor.

In particular embodiments, memory 804 includes main memory for storing instructions for processor 802 to execute or data for processor 802 to operate on. As an example and not by way of limitation, computer system 800 may load instructions from storage 806 or another source (such as, for example, another computer system 800) to memory 804. Processor 802 may then load the instructions from memory 804 to an internal register or internal cache. To execute the instructions, processor 802 may retrieve the instructions from the internal register or internal cache and decode them. During or after execution of the instructions, processor 802 may write one or more results (which may be intermediate or final results) to the internal register or internal cache. Processor 802 may then write one or more of those results to memory 804. In particular embodiments, processor 802 executes only instructions in one or more internal registers or internal caches or in memory 804 (as opposed to storage 806 or elsewhere) and operates only on data in one or more internal registers or internal caches or in memory 804 (as opposed to storage 806 or elsewhere). One or more memory buses (which may each include an address bus and a data bus) may couple processor 802 to memory 804. Bus 812 may include one or more memory buses, as described below. In particular embodiments, one or more memory management units (MMUs) reside between processor 802 and memory 804 and facilitate accesses to memory 804 requested by processor 802. In particular embodiments, memory 804 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 804 may include one or more memories 804, where appropriate. Although this disclosure describes and illustrates particular memory, this disclosure contemplates any suitable memory.

In particular embodiments, storage 806 includes mass storage for data or instructions. As an example and not by way of limitation, storage 806 may include a hard disk drive (HDD), a floppy disk drive, flash memory, an optical disc, a magneto-optical disc, magnetic tape, or a Universal Serial Bus (USB) drive or a combination of two or more of these. Storage 806 may include removable or non-removable (or fixed) media, where appropriate. Storage 806 may be internal or external to computer system 800, where appropriate. In particular embodiments, storage 806 is non-volatile, solid-state memory. In particular embodiments, storage 806 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 806 taking any suitable physical form. Storage 806 may include one or more storage control units facilitating communication between processor 802 and storage 806, where appropriate. Where appropriate, storage 806 may include one or more storages 806. Although this disclosure describes and illustrates particular storage, this disclosure contemplates any suitable storage.

In particular embodiments, I/O interface 808 includes hardware, software, or both, providing one or more interfaces for communication between computer system 800 and one or more I/O devices. Computer system 800 may include one or more of these I/O devices, where appropriate. One or more of these I/O devices may enable communication between a person and computer system 800. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 808 for them. Where appropriate, I/O interface 808 may include one or more device or software drivers enabling processor 802 to drive one or more of these I/O devices. I/O interface 808 may include one or more I/O interfaces 808, where appropriate. Although this disclosure describes and illustrates a particular I/O interface, this disclosure contemplates any suitable I/O interface.

In particular embodiments, communication interface 810 includes hardware, software, or both providing one or more interfaces for communication (such as, for example, packet-based communication) between computer system 800 and one or more other computer systems 800 or one or more networks. As an example and not by way of limitation, communication interface 810 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 810 for it. As an example and not by way of limitation, computer system 800 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 800 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 800 may include any suitable communication interface 810 for any of these networks, where appropriate. Communication interface 810 may include one or more communication interfaces 810, where appropriate. Although this disclosure describes and illustrates a particular communication interface, this disclosure contemplates any suitable communication interface.

In particular embodiments, bus 812 includes hardware, software, or both coupling components of computer system 800 to each other. As an example and not by way of limitation, bus 812 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 812 may include one or more buses 812, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
by a computing device, generating a table by instantiating a plurality of cell instances, the cell instances being oriented along an axis, wherein each of the cell instances has a default dimension along the axis;
by the computing device, buffering a first subset of the cell instances, the buffering comprising:
assigning each of the cell instances in the first subset a respective cell position within a displayable region of a graphical user interface (GUI) of the computing device, and
rendering content for display in each of the cell instances in the first subset;
by the computing device, providing a resizable handle for a scrollbar for display, the scrollbar being oriented along the axis, the resizable handle having an initial size, the initial size being determined based on a total number of cells in the table and dimensions of the cell instances, the dimensions including dimensions of the cell instances in the first subset and dimensions of unbuffered ones of the cell instances; and
by the computing device, after a predetermined period of time during which no user input manipulating the scrollbar is received at the computing device, buffering a second subset of the cell instances.

2. The method of claim 1, further comprising:
determining a respective dimension along the axis for each of the cell instances in the first subset based on the rendered content of the cell instance.

3. The method of claim 2, wherein the dimensions of the cell instances comprises the determined dimensions for the first subset of cell instances and the default dimensions for the unbuffered cell instances.

4. The method of claim 1, wherein the buffering the second subset of cell instances comprises:
assigning each of the cell instances in the second subset a respective cell position outside of the displayable region; and
rendering content for display in each of the cell instances in the second subset.

5. The method of claim 4, further comprising, determining a respective dimension along the axis for each of the cell instances in the second subset based on the rendered content of the cell instance.

6. The method of claim 5, further comprising:
determining an updated size of the resizable handle based on the determined dimensions along the axis for the cell instances in the second subset; and
providing an updated resizable handle for display, the updated resizable handle having the updated size.

7. The method of claim 1, further comprising:
in response to receiving a user input manipulating the resizable handle, determining that a new cell position is within the displayable region;
determining that no buffered cell instance is assigned to the new cell position;
selecting an unbuffered one of the cell instances; and
buffering the selected cell instance by assigning the selected cell instance to the new cell position and rendering content for display in the selected cell instance.

8. The method of claim 1, further comprising:
in response to receiving a user input manipulating the resizable handle, determining that a new cell position is within the displayable region;
determining that all of the cell instances are buffered, wherein each of the cell instances is assigned to a respective cell position, none of the respective cell positions being the new cell position;
selecting one of the buffered cell instances to be recycled; and
recycling the selected cell instance by re-assigning the selected cell instance to the new cell position and rendering content for display in the selected cell instance.

9. The method of claim 8, wherein selecting the buffered cell instance to recycle is based on a distance along the axis between a cell position of the buffered cell instance and a boundary of the displayable region.

10. The method of claim 1, wherein the plurality of cell instances comprises a plurality of row instances, the default dimension of each row instance being a default height along the axis.

11. The method of claim 1, wherein the plurality of cell instances comprises a plurality of column instances, the default dimension of each column instance being a default width along the axis.

12. The method of claim 1, wherein the table comprises a fixed header cell instance.

13. The method of claim 1, wherein at least one of the buffered cell instances comprises at least one sub-cell instance.

14. The method of claim 1, wherein at least one of the cell instances comprises a plurality of data cells, and wherein rendering content for display in the at least one cell instance comprises executing at least one callback function with respect to at least one of the data cells.

15. One or more computer-readable non-transitory storage media embodying software that is operable when executed to:
generate a table by instantiating a plurality of cell instances, the cell instances being oriented along an axis, wherein each of the cell instances has a default dimension along the axis;
buffer a first subset of the cell instances, the buffering comprising:
assign each of the cell instances in the first subset a respective cell position within a displayable region of a graphical user interface (GUI) of the computing device, and
render content for display in each of the cell instances in the first subset;
provide a resizable handle for a scrollbar for display, the scrollbar being oriented along the axis, the resizable handle having an initial size, the initial size being determined based on a total number of cells in the table and dimensions of the cell instances, the dimensions including dimensions of the cell instances in the first subset and dimensions of unbuffered ones of the cell instances; and
after a predetermined period of time during which no user input manipulating the scrollbar is received at the computing device, buffer a second subset of the cell instances.

16. The media of claim 15, wherein the software is further operable when executed to:
in response to receiving a user input manipulating the resizable handle, determine that a new cell position is within the displayable region;
determine that no buffered cell instance is assigned to the new cell position;
select an unbuffered one of the cell instances; and
buffer the selected cell instance by assigning the selected cell instance to the new cell position and rendering content for display in the selected cell instance.

17. The media of claim 15, wherein the software is further operable when executed to:
in response to receiving a user input manipulate the resizable handle, determining that a new cell position is within the displayable region;
determine that all of the cell instances are buffered, wherein each of the cell instances is assigned to a respective cell position, none of the respective cell positions being the new cell position;
select one of the buffered cell instances to be recycled; and
recycle the selected cell instance by re-assigning the selected cell instance to the new cell position and rendering content for display in the selected cell instance.

18. The method of claim 17, wherein the selecting the buffered cell instance to recycle is based on a distance along the axis between a cell position of the buffered cell instance and a boundary of the displayable region.

19. A system comprising: one or more processors; and a memory coupled to the processors comprising instructions executable by the processors, the processors operable when executing the instructions to:
generate a table by instantiating a plurality of cell instances, the cell instances being oriented along an axis, wherein each of the cell instances has a default dimension along the axis;
buffer a first subset of the cell instances, the buffering comprising:
assign each of the cell instances in the first subset a respective cell position within a displayable region of a graphical user interface (GUI) of the computing device, and
render content for display in each of the cell instances in the first subset;
provide a resizable handle for a scrollbar for display, the scrollbar being oriented along the axis, the resizable handle having an initial size, the initial size being determined based on a total number of cells in the table and dimensions of the cell instances, the dimensions including dimensions of the cell instances in the first subset and dimensions of unbuffered ones of the cell instances; and
after a predetermined period of time during which no user input manipulating the scrollbar is received at the computing device, buffer a second subset of the cell instances.
